(19) United States
(12) Patent Application Publication
(10) Pub. No.: US 2018/0084777 A1
(43) Pub. Date: Mar. 29, 2018

(54) Low Residue Disinfecting Wipes

(71) Applicant: Lonza Inc., Allendale, NJ (US)

(72) Inventor: Xiao Jiang, Montvale, NJ (US)

(21) Appl. No.: 15/715,371

(22) Filed: Sep. 26, 2017

Related U.S. Application Data
(60) Provisional application No. 62/400,663, filed on Sep. 28, 2016.

(51) Int. Cl. A01N 25/30; A01N 33/12; C11D 17/04; C11D 3/48; C11D 1/90

(52) U.S. Cl. CPC A01N 25/30; A01N 33/12; C11D 1/90; C11D 3/48; C11D 17/049

(57) ABSTRACT

The present disclosure is directed to a wiping composition. The composition contains a quaternary ammonium compound in a concentration sufficient to have antimicrobial efficacy. In order to reduce streaking and/or film formation during use of the wiping composition, the composition further contains a residue reducing surfactant. In one embodiment, the residue-reducing surfactant comprises a betaine surfactant.

### RELATED APPLICATIONS

The present application is based on and claims priority to U.S. Provisional Patent application Ser. No. 62/400,663, filed on Sep. 28, 2016, which is incorporated herein by reference.

### BACKGROUND

Pathogenic organisms, such as bacteria, fungi, and viruses, continue to cause infections in humans as well as domestic animals and pets. In recent years, there has been a particular growing concern over food-borne pathogens and the potential for them to contaminate the food chain. Disinfectant formulations have been developed over the last several decades to reduce or destroy pathogenic organisms and accordingly, reduce the rate of infection. Literally any hard surface including floors, walls, countertops, windows, windowsills, sinks, faucets, waste containers, appliances, and cabinet surfaces can become contaminated. Disinfectants have been developed to treat hard surfaces for use in hospitals, rest homes, schools, and homes. Antimicrobial compositions for decontamination, disinfection and/or sanitization can be added to wipes in order to treat such surfaces.

One particular class of antimicrobial compositions includes quaternary ammonium compounds, also known as “quats”, as a microbial control agent. The use of quats as biocides is well known.

In hard surface cleaning/disinfecting wipe applications, a desired product should exhibit good cleaning and disinfecting performance and at the same time leave the surface visually clean of spots, streaks, and films. Most cationic formulations, such as quat-based wipe disinfectant formulations, leave significant residues that are particularly noticeable on smooth glossy surfaces.

In one application, the antimicrobial composition may be incorporated into a wiping product and packaged as a premoistened wipe. These products are generally inexpensive to manufacture, are easy to use, and are disposable after use. Problems with streaking and film residue, however, are exacerbated when using premoistened wipes in that the products leave the surfaces in a wet state and are not dry wiped.

There have been attempts to create compositions which leave minimal residue. For example, a C₈ to C₁₀ alkylpolyglucoside (APG) surfactant and an amine oxide surfactant have been used in an attempt to produce a low residue wipe.

The known low streaking surfactant compounds can reduce streaking but tend to exhibit filming on the hard surface after application, especially when the hard surface is exposed to higher humidity conditions.

The present disclosure is directed to a wiping composition and/or to premoistened wipes containing a wiping composition that reduces streaking and film formation after application of the composition to an adjacent surface. More particularly, the present disclosure is directed to a wiping composition containing a quaternary ammonium cation that produces reduced visible residues after use, even when applied to a smooth glossy surface.

### SUMMARY

In general, the present disclosure is directed to a wiping composition having antimicrobial properties. The wiping composition contains a quaternary ammonium cation in combination with a residue reducing surfactant. The residue reducing surfactant is present in an amount sufficient to reduce streaking and/or film formation. In one embodiment, the residue reducing surfactant comprises an amphoteric surfactant or a zwitterionic surfactant. In one particular embodiment, the residue reducing surfactant comprises a betaine surfactant. In one embodiment, the antimicrobial agent comprising the quaternary ammonium cation is present in the wiping composition in relation to the residue reducing surfactant at a weight ratio of from about 1:0.2 to about 1:10, such as from about 1:0.5 to about 1:5.

The quaternary ammonium cation can generally comprise any suitable antimicrobial agent. For instance, the quaternary ammonium cation may comprise a halide salt of a quaternary ammonium cation. Particular examples of quaternary ammonium cations include an alkyl dimethyl benzyl ammonium chloride, a dialkyl dimethyl ammonium chloride, an alkyl dimethyl ethyl benzyl ammonium chloride, or mixtures thereof.

In an alternative embodiment, the quaternary ammonium cation can comprise a carbonate/bicarbonate salt of a quaternary ammonium cation.

The betaine surfactant, on the other hand, may comprise any suitable betaine surfactant capable of reducing streaking and/or film formation. In one embodiment, the betaine surfactant may have the following formula:

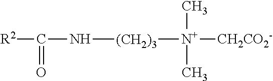

wherein R² comprises an alkyl group having up to 20 carbon atoms.

The betaine surfactant may comprise a cocoamidopropyl betaine. Other betaine surfactants that may be used in the composition include decyl betaine, myristyl betaine, palmityl betaine, lauryl betaine, cetyl betaine, stearyl betaine, coco dimethyl carboxymethyl betaine (“cocobetaine”), cocoamidoethyl betaine, cocoamidopropyl betaine, lauramidopropyl betaine, myristyl amidopropyl betaine, lauryl dimethyl carboxymethyl betaine, lauryl dimethyl alpha-carboxy-ethyl betaine, cetyl dimethylcarboxymethyl betaine, lauryl bis-(2-hydroxy-ethyl) carboxy methyl betaine, stearyl bis-(2-hydroxy-propyl) carboxymethylbetaine, oleyl dimethyl gamma-carboxypropyl betaine, lauryl bis-(2-hydroxypropyl) alpha-carboxyethyl betaine, cocoamidopropyl dimethyl betaine, or mixtures thereof.

In one embodiment, the residue reducing surfactant may comprise a polymeric betaine. The polymeric betaine may have the following formula:

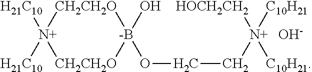

In addition to an antimicrobial agent and a residue reducing surfactant, the wiping composition generally contains at least one solvent, such as water. For instance, water can be present in an amount greater than about 90% by weight, such as in an amount greater than about 95% by weight. In one embodiment, the only solvent present within the composition comprises water. Alternatively, water may be present in combination with an organic solvent, such as an alcohol or a glycol ether.

The composition may also contain various other components such as a chelating agent, a pH builder, an organic solvent, or the like. In one particular embodiment, the composition contains a chelating agent and a pH builder. The pH builder comprises a silicate. The composition can further contain at least one nonionic surfactant. The nonionic surfactant may comprise an ethoxylated alcohol. The antimicrobial agent may be present in the aqueous solution in an amount less than about 2% by weight, such as in an amount less than about 1% by weight. The residue reducing surfactant can also be present in the aqueous solution in an amount less than about 2% by weight, such as in an amount less than about 1% by weight.

In one embodiment, the present disclosure is directed to a premoistened wiping product containing the wiping composition described above. The premoistened wiping product may comprise a liquid absorbent substrate impregnated with the wiping composition. The liquid absorbent substrate may comprise a melt blown web, a coform web, a spunbond web, an airlaid web, and airlaced web, a hydroentangled web, a bonded carded web, or a laminate thereof.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

A low residue antimicrobial composition is generally disclosed. The antimicrobial composition may be used to impregnate a cleaning wipe. The composition contains a quaternary ammonium antimicrobial agent and a residue reducing surfactant. The present inventors discovered novel surfactant compounds that can reduce visible residues (film and streaking) significantly on hard surfaces when used with quat-based disinfectant formulations. The use of the residue reducing surfactant compounds in accordance with the present disclosure can outperform known low residue surfactant compounds such as alkyl polyglucosides (APG) and amine oxides.

As mentioned, the composition comprises a quaternary ammonium antimicrobial compound. Preferably, the quaternary ammonium compound is a quaternary ammonium salt, such as a halide salt or a carbonate/bicarbonate salt. The composition further comprises a residue reducing surfactant. For example, in one embodiment, the residue reducing surfactant comprises an amphoteric surfactant. In one embodiment, the residue reducing surfactant may comprise a betaine surfactant. The betaine surfactant can be a betaine or sulfobetaine surfactant. In one embodiment, the residue reducing surfactant may comprise a polymeric betaine surfactant and/or a betaine ester surfactant. The composition may further contain additional ingredients, including solvents, surfactants, PH builders, chelators, builder salts, dyes, fragrances and the like that are commonly used in the art in cleaning and disinfecting solutions.

Quaternary ammonium compounds, also known as “quats”, typically comprise at least one quaternary ammonium cation with an appropriate anion. Quats will generally have the general formula (1).

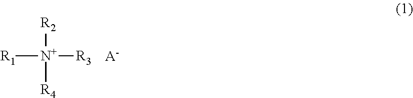

The groups R₁, R₂, R₃ and R₄ can vary within wide limits and examples of quaternary ammonium compounds that have anti-microbial properties will be well known to the person of ordinary skill in the art. Typically, two of R₁, R₂, R₃ and R₄ are lower alkyl, meaning having 1 to 4 carbon atoms, such as methyl, ethyl, propyl or butyl groups. In addition, two of R₁, R₂, R₃ and R₄ are longer chain alkyl groups of 6 to 24 carbon atoms, or a benzyl group. A⁻ is a monovalent anion or one equivalent of a polyvalent anion of an inorganic or organic acid. Suitable anions for A⁻ are in principle all inorganic or organic anions, in particular halides, for example chloride or bromide, carbonates, bicarbonates, carboxylates, sulfonates, phosphates or a mixture thereof. Carboxylates may be derived from lower carboxylic acids or from fatty acids.

Alkyl, hereinafter, is taken to mean in each case unbranched or branched alkyl groups of the specified number of carbons, but preferably unbranched alkyl groups, and particularly preferably those having an even number of carbon atoms. In particular, this is also taken to mean the homologue mixtures derived from natural raw materials, for example “cocoalkyl”.

In one embodiment, the quaternary ammonium compound may have the following R groups: R₁ is benzyl or C₆₋₁₈ alkyl, R₂ is C₁₋₁₈ alkyl or —[(CH₂)₂—O]ₙR₅ where n=1-20, R₃ and R₄ independently of one another are C₁₋₄ alkyl, R₅ is hydrogen or unsubstituted or substituted phenyl, and A⁻ is a monovalent anion or one equivalent of a polyvalent anion of an inorganic or organic acid.

Substituted phenyl is taken to mean, in particular, phenyl groups substituted with one or more C₁₋₁₈ alkyl groups and/or halogen atoms.

Suitable quaternary ammonium compounds include, but are not limited to, alkyldimethylbenzyl ammonium chlorides, dialkylmethylbenzyl ammonium chlorides, dialkyldimethylammonium chlorides, alkyl dimethyl ethylbenzyl quaternary ammonium chlorides, benzethonium chloride and any combination of any of the foregoing.

In one embodiment, the quaternary ammonium compound may comprise a dialkyl ammonium compound, such as a dimethyl dialkyl ammonium compound. In one embodiment, the dimethyl dialkyl ammonium compound may have between about 8 and about 12 carbon atoms, such as from about 8 to about 10 carbon atoms in each of the alkyl groups.

Examples of dimethyl dialkyl ammonium compounds include dimethyl dioctyl ammonium compounds such as dimethyl dioctyl ammonium chloride, dimethyl didecyl ammonium compounds such as dimethyl didecyl ammonium chloride and the like. Mixtures of dimethyl dialkyl ammonium compounds may also be used, and other anions, such as those described above, may also be used. Commercially available dimethyl dialkyl ammonium compounds include, for example, compositions marketed and sold under the BARDAC,® BARQUAT® or CARBOQUAT® trade names by Lonza Inc.

Such commercially available examples of dimethyl dialkyl ammonium compounds include dioctyldimethylammonium chloride (available as Bardac® LF and LF-80 from Lonza, Inc.), octyldecyldimethylammonium chloride (available as a mixture of octyldecyldimethylammonium chloride, dioctyldimethylammonium chloride, and didecyldimethyl ammonium chloride as Bardac® 2050 and 2080 from Lonza, Inc.), didecyldimethylammonium chloride (available as Bardac® 2250 and 2280 from Lonza, Inc.), decylisononyldimethylammonium chloride (available as Bardac® 21 from Lonza, Inc.), diisodecyldimethylammonium chloride (available as BTC 99 from Stepan Co. of Northfield, Ill.), and any combination of any of the foregoing.

In an alternative embodiment, the quaternary ammonium compound may comprise a benzyl ammonium compound, such as an alkyl dimethyl benzyl ammonium compound. In general, the alkyl group may contain from about 10 to about 18 carbon atoms, such as from about 12 to about 16 carbon atoms.

Examples of alkyl dimethyl benzyl ammonium compounds useable as the first biocide include C₁₂ alkyl dimethyl benzyl ammonium chloride, C₁₄ alkyl dimethyl benzyl ammonium chloride, and C₁₆ alkyl dimethyl benzyl ammonium chloride. In addition, a mixture of these alkyl dimethyl benzyl ammonium compounds can be used. Commercially available alkyl dimethyl benzyl ammonium compounds include, for example, compositions marketed and sold under the BARQUAT® trade name by Lonza Inc. These commercially available alkyl dimethyl benzyl ammonium compounds are blends of C₁₂, C₁₄, and C₁₆ alkyl dimethyl benzyl ammonium chlorides. Generally, it is preferable that the alkyl dimethyl benzyl ammonium compound, when a blend, contains higher concentrations of C₁₂ alkyl and C₁₄ alkyl components than C₁₆ alkyl components. It is noted that other anions, including those mentioned above may also be used.

Non-limiting examples of alkyldimethylbenzyl ammonium chlorides include alkyl (C₁₄ 50%; C₁₂ 40%, C₁₆ 10%) dimethylbenzyl ammonium chloride (available as Barquat® MB-50 and MB-80 from Lonza Inc.), alkyl (C₁₄ 60%; C₁₆ 30%; C₁₂ 5%. C₁₈ 5%) dimethylbenzyl ammonium chloride (available as Barquat® 4280Z from Lonza, Inc.), (C₁₂-C₁₈ alkyl) dimethylbenzyl ammonium chloride, and any combination of any of the foregoing.

In still another embodiment, the antimicrobial agent may comprise a quaternary ammonium carbonate. A quaternary ammonium carbonate can be represented by the following formula:

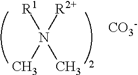

wherein R1 is a C1-C20 alkyl or aryl-substituted alkyl group and R2 is a C8-C20 alkyl group, and preferably wherein R1 is the same as R2 and R1 is a C8-C12 alkyl group, as well as compositions further comprising the corresponding quaternary ammonium bicarbonate

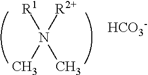

wherein R1 is the same or a different C1-C20 alkyl or aryl-substituted alkyl group as above and R2 is the same or a different C8-C20 alkyl group as above, but preferably wherein R1 is the same as R2 and R1 is a C8-C12 alkyl group.

In one embodiment, the ammonium quaternary compound contained in the composition comprises a di C8-C12 alkyl ammonium carbonate/bicarbonate. For example, in one particular embodiment, the antimicrobial agent comprises didecyl dimethyl ammonium carbonate and didecyl dimethyl ammonium bicarbonate.

In other embodiments, however, the carbonate/bicarbonate salts of quaternary ammonium cations may be selected from dioctyldimethylammonium carbonate, decyloctyldimethylammonium carbonate, benzalkonium carbonate, benzethonium carbonate, stearalkonium carbonate, cetrimonium carbonate, behentrimonium carbonate, dioctyldimethylammonium bicarbonate, decyloctyldimethylammonium bicarbonate, benzalkonium bicarbonate, benzethonium bicarbonate, stearalkonium bicarbonate, cetrimonium bicarbonate, behentrimonium bicarbonate, and mixtures of one or more such carbonate salts.

It should be understood that the quaternary ammonium compound may comprise more than one specific quaternary ammonium species and may comprise a combination of any of the above described quaternary ammonium compounds.

The quaternary ammonium compound may be present in the composition in an amount of from about 0.1% to about 25% by weight based on the total weight of the antimicrobial composition. Preferably, the quaternary ammonium compound is present in the composition in an amount of from about 0.25% to about 20% by weight. The concentration of the quaternary ammonium compound in the composition in a ready to use (RTU) form which may be applied to a wipe substrate is preferably from about 0.1% to about 3%, such as from about 0.2% to about 2% based on weight of the RTU composition. In a concentrated composition, the quaternary ammonium compound can be present in the composition in an amount of from about 5% to about 40% by weight, such as from about 10% to about 20% based on weight of the concentrated composition.

In addition to the antimicrobial agent, the wiping composition of the present disclosure also contains a residue reducing surfactant. In one embodiment, the residue reducing surfactant may comprise an amphoteric surfactant or a zwitterionic surfactant. In one particular embodiment, the residue reducing surfactant comprises a betaine surfactant. The betaine surfactant may comprise betaines and sulfobetaines of the formula (2)

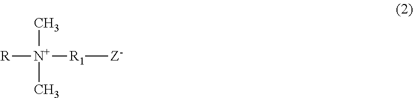

wherein R is alkyl or (3)

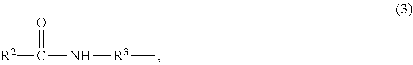

Z⁻ is COO⁻ or SO₃⁻, R₁ is alkyl or hydroalkyl, R₂ is alkyl of up to about 20 carbon atoms, preferably about 6 to about 16 carbon atoms, and R₃ is alkyl.

In one embodiment, the betaine surfactant may have the following formula:

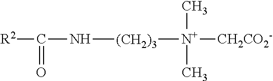

Wherein R² comprises an alkyl group having up to about 20 carbon atoms, such as from about 6 carbon atoms to about 16 carbon atoms.

Examples of betaines useful herein include decyl betaine or 2-(N-decyl-N,N-dimethylammonio) acetate, myristyl betaine, palmityl betaine, lauryl betaine, cetyl betaine, stearyl betaine, coco dimethyl carboxymethyl betaine (“cocobetaine”), cocoamidoethyl betaine, cocoamidopropyl betaine, lauramidopropyl betaine, myristyl amidopropyl betaine, lauryl dimethyl carboxymethyl betaine, lauryl dimethyl alpha-carboxy-ethyl betaine, cetyl dimethylcarboxymethyl betaine, lauryl bis-(2-hydroxy-ethyl) carboxy methyl betaine, stearyl bis-(2-hydroxy-propyl) carboxymethylbetaine, oleyl dimethyl gamma-carboxypropyl betaine, lauryl bis-(2-hydroxypropyl) alpha-carboxyethyl betaine, cocoamidopropyl dimethyl betaine, and mixtures thereof and the like.

Particular examples of betaine surfactants include cocobetaine sold by Witco Chemical Corporation under the name EMCOL CC 37-18 and cocoamidopropyl betaine sold by Lonza Inc. under the name LONZAINE CO.

Examples of sulfobetaine surfactants include 3-(N,N-dimethyl-N-acylamidopropylammonio)-2-hydroxy-propane-1-sulfonates, wherein the acyl group is derived from tallow fatty alcohol or coconut fatty alcohol, with coconut fatty alcohol preferred. It will be recognized by those skilled in the art that, in the normal preparation of these derivatives of tallow or coconut fatty alcohols, a mixture of sulfobetaines with varying carbon chain lengths for the acyl groups will result. These fatty alcohols contain, for the most part, carbon chain lengths that will provide acyl groups with the desired number of carbon atoms, i.e., from about 8 to about 18 carbon atoms. Thus, these mixtures obtained from tallow or coconut fatty alcohols are useful in providing the sulfobetaine surfactant for reagents of the present disclosure. A material of this type for use in compositions of the present disclosure is N-cocoamido-propyl-N,N-dimethyl-N-2-hydroxypropyl sulfobetaine. An example of this is LONZAINE CS, which is commercially available from Lonza, Inc.

Sulfobetaines which are suitable for the antimicrobial composition may be represented by coco dimethyl sulfopropyl betaine, stearyl dimethyl sulfopropyl betaine, lauryl dimethyl sulfoethyl betaine, lauryl bis-(2-hydroxy-ethyl) sulfopropyl betaine and the like; amido betaines and amidosulfobetaines, wherein an RCONH(CH2)x radical is attached to the nitrogen atoms of the betaine can also be useful.

The betaine may also comprise a betaine polymer, such as an amphiphilic betaine polymer. The polymeric betaine, for instance, may comprise a complex of a dialkyl disalkoxylated quaternary ammonium salt with boric acid. Other similar compounds may also include quaternary amine salts formed by the protonation of monoalkylamines, dialkylamines, trialkylamines and monobisalkoxylated amines. In one particular embodiment, the polymeric betaine may comprise didecyl bis(hydroxyethyl) ammonium borate. The polymeric betaine may have the following formula:

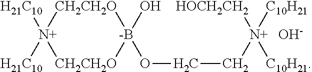

The wiping composition of the present disclosure may contain a single betaine as described above or a combination of betaines. In one embodiment, for instance, a betaine according to formulas 2 and 3 above may be combined with a polymeric betaine.

The betaine may be present in the antimicrobial composition in an amount from about 0.05% about 30% by weight based on the weight of the composition. In a RTU composition, the betaine is preferably present in an amount from about 0.2% to about 5%, such as from about 0.3% to about 3%, and particularly from about 0.5% to about 1.0% based on weight of the RTU composition. In one embodiment, the residue reducing surfactant is present in the composition in an amount less than about 2% by weight, such as in an amount less than about 1.5% by weight. In a concentrated composition, the betaine is preferably present in an amount from about 10% to about 30%, such as from about 15% to about 25% based on weight of the concentrated composition.

The betaine can be present in an amount greater than the amount of quaternary ammonium compound present. The antimicrobial agent can be present in the composition in relation to the residue reducing surfactant such that the weight ratio between the antimicrobial agent and the residue reducing surfactant is from about 1:0.2 to about 1:10, such as from about 1:0.5 to about 1:5, such as from about 1:0.9 to about 1:3.

It has been found that the presence of a betaine surfactant does not impact the efficacy of the quat-based antimicrobial composition.

In addition to the antimicrobial agent and the residue reducing surfactant, the wiping composition of the present disclosure can contain various other components and ingredients. For instance, the composition may contain a pH builder, a chelating agent, other surfactants, a solvent in addition to water such as an organic solvent, a building salt, fragrances, preservatives, and the like. Each of the above described additives can be present alone or in combination with other additives.

For instance, the antimicrobial composition may also contain a pH builder. Suitable pH builders include sodium hydroxide, potassium hydroxide, potassium carbonate, sodium citrate, sodium carbonate, silicates such as sodium metasilicate, and other similar compounds. Preferred is sodium metasilicate pentahydrate.

It has also been discovered that alkanolamines are effective in raising the pH of the composition with adversely affecting the function of the quaternary ammonium compounds. Essentially any alkanolamine may be used, including mono, di and tri alkanolamines. One particularly useful alkanolamine is monoethanolamine.

The pH builder is preferably present in the composition in an amount from about 0.01% to about 2%, such as from about 0.02% to about 1%, based on weight of the composition. In one embodiment, the wiping composition has a pH of greater than about 8, such as greater than about 9, such as greater than about 10. The pH is generally less than about 14, such as less than about 12. In one particular embodiment, for instance, the wiping composition can have a pH of from about 10 to about 12. The pH builder can be added in an amount sufficient for the composition to have a pH within the above range.

The composition may also contain a chelating agent. Suitable chelating agents include, but are not limited to, ethylene diamine tetra acetic acid (EDTA) and salts thereof (e.g., tetrasodium EDTA available as Versene 100® from Dow Europe S.A. of Horgen, Switzerland), nitrilotriacetic acid (NTA), and diammonium ethylene diamine tetraacetate. The ability of NTA and EDTA to remove metal ions facilitates of the solution by preventing hardness (calcium) precipitation. The chelating agent may also serve to bind other metal ions that may adversely affect the effectiveness of the disinfecting components in the composition.

The chelating agent is preferably present in the composition in an amount of from about 0.01% to about 10%, such as from about 0.04% to about 6% based on weight of the composition.

Nonionic surfactants can also be included in the composition in addition to the residue reducing surfactant. A nonionic surfactant, in one embodiment, can be broadly defined as compounds produced by the condensation of a hydrophilic alkylene oxide group with an aliphatic or alkyl aromatic hydrophobic compound. Examples of preferred classes of nonionic surfactants are:

Long chain tertiary amine oxides corresponding to the following general formula:

R₁R₂R₃N→O

wherein R₁ contains an alkyl, alkenyl or monohydroxy alkyl radical of from about 8 to about 18 carbon atoms, up to about 10 ethylene oxide moieties, and up to 1 glyceryl moiety, and R₂ and R₃ contain from 1 to about 3 carbon atoms and up to about 1 hydroxy group, e.g., methyl, ethyl, propyl, hydroxyethyl, or hydroxypropyl radicals. Examples of amine oxides suitable for use in this invention include: dimethyldodecylamine oxide, oleyldi(2-hydroxyethyl)amine oxide, dimethyloctylamine oxide, dimethyldecylamine oxide, dimethyltetradecylamine oxide, di(2-hydroxyethyl)tetradecylamine oxide, 3-dodecoxy-2-hydroxypropyldi(3-hydroxypropyl)amine oxide, and dimethylhexadecylamine oxide.

The polyethylene oxide condensates of alkyl phenols, e.g., the condensation products of alkyl phenols having an alkyl group containing from about 6 to 12 carbon atoms in either a straight chain or branched chain configuration, with ethylene oxide, the said ethylene oxide being present in amounts equal to 6 to 60 moles of ethylene oxide per mole of alkyl phenol. The alkyl substituent in such compounds may be derived from polymerized propylene, diisobutylene, octane, or nonane.

Those derived from the condensation of ethylene oxide with the product resulting from the reaction of propylene oxide and ethylene diamine products which may be varied in composition depending upon the balance between the hydrophobic and hydrophilic elements which is desired. For example, compounds containing from about 40% to about 80% polyoxyethylene by weight and having a molecular weight of from about 5,000 to about 11,000 resulting from the reaction of ethylene oxide groups with a hydrophobic base constituted of the reaction product of ethylene diamine and excess propylene oxide, said base having a molecular weight of the order of 2,500 to 3,000, are satisfactory.

The condensation product of straight or branched chain aliphatic alcohols having from 8 to 18 carbon atoms with ethylene oxide, e.g., a coconut alcohol ethylene oxide condensate having from 10 to 30 moles of ethylene oxide per mole of coconut alcohol, the coconut alcohol fraction having from 10 to 14 carbon atoms.

Particular surfactants that may be used in the composition are nonyl phenol ethoxylates (6-12 moles), primary alcohol ethoxylates (3-12 moles), and secondary alcohol ethoxylates (3-12 moles).

The nonionic surfactants described herein are selected to adsorb or otherwise bond to the fibers of a dry substrate of the cleaning wipe, thereby preventing the active disinfectants from being adsorbed by the fibers of the dry substrate. Without being bound by theory, it is believed that the nonionic surfactants described herein alter the relative equilibrium at the cleaning wipe surface by both modifying the surface to make it less hydrophobic and modifying the wiping composition to make it less hydrophilic. For example, in the case of a quat solution, such as a dialkyl or alkyl benzyl quat solution, the net result is a reduced attraction of the hydrophobic wiper surface for the hydrophobic hydrocarbon tails of the quat solution. The hydrophobic groups have an affinity for the fiber surface of the substrate. Unlike anionic surfactants, the nonionic nature of the surfactant does not attract the cationic quat-based or chlorine-based disinfectant solutions and prevents the active disinfectant from bonding to the substrate fibers.

Exemplary commercially available nonionic surfactants of this composition are C11-C15 secondary alkanols condensed with 7, 9, 12, 20, or 40 moles of ethylene oxide (alkyloxypolyethylene oxyethanols), produced by Dow Chemical under the tradenames Tergitol® 15-S-7, 15-S-9, 15-S-12, 15-S-20, and 15-S-40. Additional exemplary nonionic surfactants, of the same type, are marketed by Dow Chemical under the tradenames Tergitol® TMN-6 and TMN-10, believed to comprise reaction products of trimethyl-nonanol with ethylene oxide. Other exemplary nonionic surfactants are commercially available from BASF under the tradename Irgasurf® HL 560. Still other nonionic surfactants include block copolymers of polyoxyethylene and polyoxypropylene that are available under the trade name Pluronic®, marketed by BASF. A single member of any of the foregoing nonionic surfactant compositions can be used in the wiping composition, or mixtures of such exemplary nonionic surfactant materials can be employed.

The amount of the nonionic surfactant in the composition is preferably from about 0.01% to about 5% based on weight of the composition. Typically, the composition contains from about 0.05% to about 3% of nonionic surfactant. Alternatively, the composition may not include a non-ionic surfactant. Further, the composition may be free of alkyl polyglycoside (APG) and amine oxide surfactants. In an alternative embodiment, the wiping composition may contain the residue reducing surfactant and the antimicrobial agent combined with an alkyl polyglycoside, an amine oxide, or a mixture of both.

The antimicrobial composition of the present disclosure can be supplied as a concentrate, which is diluted to use levels prior to use. Alternatively, the disinfecting composition can be provided as a Ready-to-Use (RTU) composition. In either case, the composition contains a solvent.

Generally, the solvent will be a polar solvent such as water, or an organic solvent, such as an alcohol and/or a glycol ether. In one embodiment, the only solvent present in the composition is water. Alternatively, the composition may contain water in combination with an organic solvent.

Examples of organic solvents include ethanol, propanol, benzyl alcohol, phenoxyethanol, isopropanol, diethylene glycol propyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol n-butyl ether, ethylene glycol dimethyl ether, ethylene glycol diethyl ether, ethylene glycol dibutyl ether, propylene glycol n-butyl ether, propylene glycol n-propyl ether, tripropylene glycol methyl ether, dipropylene glycol methyl ether, dipropylene glycol butyl ether, dipropylene glycol n-propyl ether, ethylene glycol hexyl ether and combinations thereof.

Water can be present in the composition generally in an amount greater than about 60% by weight, such as greater than about 70% by weight, such as greater than about 80% by weight, such as greater than about 90% by weight. For example, water can be present in the composition in an amount greater than about 92% by weight, such as in an amount greater than about 94% by weight, such as in an amount greater than about 96% by weight, such as in an amount greater than about 98% by weight. Water is generally present in an amount less than about 99.5% by weight, such in an amount less than about 99% by weight, such in an amount less than about 95% by weight.

In one embodiment, the solvent comprises water and an additional organic solvent such as isopropanol, propylene glycol n-propyl ether, or propylene glycol n-butyl ether. When a solvent is present in addition to water, it is preferably present in an amount from about 0.1% to 20% based on weight of the composition. In a RTU concentration, the organic solvent in addition to water is preferably present in an amount from about 0.25% to about 2%, such as from about 0.3% to about 0.5% based on weight of the composition. In a concentrated composition, the additional solvent is preferably present in an amount from about 1% to about 15%, such as about 8% to about 12%, based on weight of the composition.

The wiping composition of the present disclosure may optionally further contain corrosion inhibitors, complexing agents, auxiliaries, preservatives, fragrances, colorants and the like. Exemplary corrosion inhibitors include, for example, organic phosphorous compounds and blend of organic phosphorous compounds with a polymeric component. Exemplary auxiliaries include, for example, polyethylene glycol or other similar compounds. Examples of building salts that may be used include sodium metasilicate, sodium tripolyphosphate, sodium nitrilotriacetate, sodium carbonate, sodium silicate, citric acid salts and zeolites. Colorants and fragrances may be added provided they do not interfere with the function of the composition and may serve for identifying the composition. Generally, the optional further ingredients will make up less than about 20% by weight of the composition. For example, each of the above identified ingredients or components can be present in the composition generally in an amount from about 0.01% by weight to about 5% by weight. For instance, each of the above components can be present in the composition in an amount from about 0.1% to about 2% by weight, such as from about 0.3% to about 1% by weight. The optional additives are added in amounts conventionally used in sanitizing and disinfecting compositions.

Advantageously, it has been found that the addition of fragrance does not change the streaking and filming performance of the composition.

One particularly useful application method is to impregnate the wiping composition into a wipe substrate. In this embodiment, the wipe is a single use wipe that is impregnated with the wiping composition and is stored in a container that will dispense the wipe to a user. The container with the wipes may contain a single wipe, or several wipes. Suitable containers include a pouch containing a single wipe, such as a moist towelette which is torn open by the user, or may be a pouch with a resealable opening containing several wipes in a stacked fashion, a rolled fashion or other suitable formation that would allow a single wipe to be removed from the opening at a time. Pouches are generally prepared form a fluid impervious material, such as a film, a coated paper or foil or other similar fluid impervious materials. In another way to dispense wipes of the present disclosure is to place the wipe in to a fluid impervious container having an opening to access the wipes in the container. Containers may be molded plastic container with lids that are fluid impervious. Generally, the lid will have an opening to access the wipes in the container. The wipe in the container may be in an interleaved stack, such that as a wipe is removed from the container, the next wipe is positioned in the opening of the container ready for the user to remove the next wipe. Alternatively, the wipe may be a continuous material which is perforated between the individual wipes of the continuous material. The continuous wipe material with perforations may be in a folded form or may be in a rolled form. Usually, in the rolled form, the wipe material is fed from the center of the rolled material. As with the interleaved stack, as a wipe is removed from the container, the next wipe is positioned in the opening to facilitate removal of the next wipe, when needed.

Disposable wipes provide advantages over other application vehicles, such as a reusable sponge, rag or the like. Unlike sponges, rags and the like, which are used repeatedly, the impregnated wipe is used a single time and disposed of. Reused sponges or rags present problems since the sponges or rags may carry microbes that are not easily killed by the disinfecting composition.

The wiping composition can be impregnated into the wipe such that the wipe is pre-moistened and will express or release the wiping composition onto the surface as the wipe is run across the surface to be treated. Generally, the wiping composition is saturated into the wipe such that the wipe will release the wiping composition to the surface through the wiping action. Generally, the wiping composition is used from about 2 parts to 6 parts by weight per 1 part by weight of the wiper substrate, more preferably from about 3 to about 5 parts by weight per 1 part by weight of the wiper substrate. In these ranges, complete saturation of the substrates can be achieved. It is noted that the amount of the wiping solution may go up or down to achieve complete saturation of the wipe substrate, depending on the particular wipe substrate.

Suitable wipe substrates include woven and nonwoven materials. Essentially any nonwoven web material may be used. Exemplary nonwoven materials may include, but are not limited to meltblown, coform, spunbond, airlaid, hydroentangled nonwovens, spunlace, bonded carded webs, and laminates thereof. Optionally, the nonwoven may be laminated with a film material as well. The fibers used to prepare the wipe substrate may be cellulosic fiber, thermoplastic fibers and mixtures thereof. The fibers may also be continuous fibers, discontinuous fibers, staple fibers and mixtures thereof. Basis weights of the nonwoven web may vary from about 12 grams per square meter to 200 grams per square meter or more.

In one embodiment the wipe is impregnated with a liquid component containing both active and inert ingredients within the allowable tolerance levels and the wiping composition expressed from the wipe contains active ingredients within the allowable tolerance levels. Once applied to the surface, the antimicrobial wiping composition is allowed to remain on the surface for a period of time. The antimicrobial composition may be applied to the surface and allowed to dry or may alternatively be dried by wiping the surface with a dry wipe or wiping device, which is preferably unused. As mentioned, it has been unexpectedly found that the described wiping composition produces less streaking and film-forming than previously known compositions when applied using a wipe, especially on glossy surfaces.

The following examples are intended to provide a more complete understanding of the present invention. The examples are not intended, however, to limit the invention.

### Examples

Quat based disinfecting samples formulated in accordance with the present disclosure were tested for streaking/filming performance and antimicrobial efficacy.

Formulation details for the disinfecting samples are provided in Table 1, 2, 3 and 4. To test streaking/filming performance, the samples were loaded onto wipe substrates with a 4.0 loading ratio. The wipe substrates were then wiped on black glass plates and allowed to dry. The black glass plates were then visually examined for filming and streaking and graded from low to medium to high.

Table 1 below provides the streaking/filming performance for samples containing various surfactants. As seen in Table 1, samples containing a betaine surfactant demonstrated lower streaking and filming than did samples containing other surfactants.

TABLE 1
Streaking/filming performance for quat based disinfecting samples containing
surfactants alkylpolyglucoside, amine oxide, and betaine

| Components | | | | | | | |
|---|---|---|---|---|---|---|---|
| (amount in wt. %, | | | | | | | |
| D.I. water added | Sample No. | | | | | | |
| to 100%) | Sample 1 | Sample 2 | Sample 3 | Sample 4 | Sample 5 | Sample 6 | Sample 7 |
| alkyl dimethyl | 0.3788 | 0.3788 | 0.3788 | 0.3788 | — | 0.3788 | 0.3788 |
| benzyl and dialkyl | | | | | | | |
| dimethyl | | | | | | | |
| ammonium | | | | | | | |
| chloride | | | | | | | |
| alkyl dimethyl | — | — | — | — | 0.3788 | — | — |
| benzyl ammonium | | | | | | | |
| chloride/alkyl | | | | | | | |
| dimethyl ethyl | | | | | | | |
| benzyl ammonium | | | | | | | |
| chloride | | | | | | | |
| sodium | 0.026 | 0.026 | 0.026 | 0.026 | 0.026 | — | — |
| metasilicate | | | | | | | |
| pentahydrate | | | | | | | |
| monoethanolamine | — | — | — | — | — | 0.026 | 0.026 |
| tetrasodium EDTA | 0.053 | 0.053 | 0.053 | 0.053 | 0.053 | 0.053 | 0.053 |
| ethoxylated alkyl | 0.105 | 0.105 | — | 0.105 | 0.105 | 0.105 | — |
| (C12-14) alcohol | | | | | | | |
| C8-C10 | — | 0.9 | — | — | — | — | — |
| alkylpolyglucoside | | | | | | | |
| (APG) | | | | | | | |
| cocodimethyl | — | — | 0.9 | — | — | — | — |
| amine oxide | | | | | | | |
| coco amido propyl | — | — | — | 0.9 | 0.9 | 0.9 | 0.9 |
| dimethyl betaine | | | | | | | |
| Streaking | High | Low | Medium | Low | Low | Low | Low |
| | | | to high | | | | |
| Filming | Medium | Medium | Medium | Low | Low | Low | Low |
| | | | to high | | | | |

Table 2 provides streaking/filming performance for quat based disinfecting samples containing a fragrance. As illustrated in Table 2, samples 9-12, which contained betaine and fragrance, had lower streaking and filming than did sample 9, which contained alkylpolyglucoside and fragrance.

TABLE 2
Streaking/filming performance for quat based disinfecting samples
containing fragrance and surfactants alkylpolyglucoside and betaine

Components

| (amount in wt. %, | Sample No. | | | | |
|---|---|---|---|---|---|
| D.I. water added | Sam- | Sam- | Sam- | Sam- | Sam- |
| to 100%) | ple 8 | ple 9 | ple 10 | ple 11 | ple 12 |
| alkyl dimethyl | 0.3788 | 0.3788 | — | 0.3788 | 0.3788 |
| benzyl and dialkyl | | | | | |
| dimethyl ammonium | | | | | |
| chloride | | | | | |
| alkyl dimethyl | — | — | 0.3788 | — | — |
| benzyl ammonium | | | | | |
| chloride/alkyl | | | | | |
| dimethyl ethyl | | | | | |
| benzyl ammonium | | | | | |
| chloride | | | | | |
| sodium metasilicate | 0.026 | 0.026 | 0.026 | — | — |
| pentahydrate | | | | | |
| monoethanolamine | — | — | — | 0.026 | 0.026 |
| tetrasodium EDTA | 0.053 | 0.053 | 0.053 | 0.053 | 0.053 |
| ethoxylated alkyl | 0.105 | 0.105 | 0.105 | 0.105 | — |
| (C12-14) alcohol | | | | | |
| C8-C10 | 0.9 | — | — | — | — |
| alkylpolyglucoside | | | | | |
| coco amido propyl | — | 0.9 | 0.9 | 0.9 | 0.9 |
| dimethyl betaine | | | | | |
| fragrance | 0.15 | 0.15 | 0.15 | 0.15 | 0.15 |
| Streaking | Low | Low | Low | Low | Low |
| Filming | Medium | Low | Low | Low | Low |

As shown in table 3, quat based disinfecting samples containing lower concentrations of betaine surfactant caused less streaking and filming than did samples containing lower concentrations of other surfactants.

TABLE 3
Streaking/filming performance for quat based disinfecting
samples containing lower concentrations of surfactants
alkylpolyglucoside and betaine

Components

| (amount in wt. %, | Sample No. | | | | |
|---|---|---|---|---|---|
| D.I. water added to | Sam- | Sam- | Sam- | Sam- | Sam- |
| 100%) | ple 13 | ple 14 | ple 15 | ple 16 | ple 17 |
| alkyl dimethyl | 0.3788 | 0.3788 | — | 0.3788 | 0.3788 |
| benzyl and dialkyl | | | | | |
| dimethyl ammonium | | | | | |
| chloride | | | | | |
| alkyl dimethyl | — | — | 0.3788 | — | — |
| benzyl ammonium | | | | | |
| chloride/alkyl | | | | | |
| dimethyl ethyl | | | | | |
| benzyl ammonium | | | | | |
| chloride | | | | | |
| sodium metasilicate | 0.026 | 0.026 | 0.026 | — | — |
| pentahydrate | | | | | |
| monoethanolamine | — | — | — | 0.026 | 0.026 |
| tetrasodium EDTA | 0.053 | 0.053 | 0.053 | 0.053 | 0.053 |
| ethoxylated alkyl | 0.105 | 0.105 | 0.105 | 0.105 | — |
| (C12-14) alcohol | | | | | |
| C8-C10 | 0.55 | — | — | — | — |
| alkylpolyglucoside | | | | | |
| coco amido propyl | — | 0.55 | 0.55 | 0.55 | 0.55 |
| dimethyl betaine | | | | | |
| Streaking | Medium | Low | Low | Low | Low |
| Filming | Medium | Low | Low | Low | Low |

Table 4 illustrates the effect of solvents on streaking and filming of quat based disinfecting samples. As seen in Table 4, samples 18, 19, and 20 containing isopropanol, propylene glycol n-butyl ether, and propylene glycol n-propyl ether demonstrated lower streaking and film performance than did the samples containing other solvents.

TABLE 4
Streaking/filming performance for quat based disinfecting samples containing betaine
and various solvents

| Components | | | | | | |
|---|---|---|---|---|---|---|
| (amount in wt. %, D.I. | Sample No. | | | | | |
| water added to | Sample | Sample | Sample | Sample | Sample | Sample |
| 100%) | 18 | 19 | 20 | 21 | 22 | 23 |
| alkyl dimethyl benzyl | 0.3788 | 0.3788 | 0.3788 | 0.3788 | 0.3788 | 0.3788 |
| and dialkyl dimethyl | | | | | | |
| ammonium chloride | | | | | | |
| monoethanolamine | 0.026 | 0.026 | 0.026 | 0.026 | 0.026 | 0.026 |
| tetrasodium EDTA | 0.053 | 0.053 | 0.053 | 0.053 | 0.053 | 0.053 |
| coco amido propyl | 0.55 | 0.55 | 0.55 | 0.55 | 0.55 | 0.55 |
| dimethyl betaine | | | | | | |
| isopropanol | 1.0 | | | | | |
| propylene glycol n- | | 1.0 | | | | |
| butyl ether | | | | | | |
| propylene glycol n- | | | 1.0 | | | |
| propyl ether | | | | | | |
| diethylene glycol n- | | | | 1.0 | | |
| butyl ether | | | | | | |
| dipropylene glycol n- | | | | | 1.0 | |
| propyl ether | | | | | | |
| ethylene glycol hexyl | | | | | | 1.0 |
| ether | | | | | | |
| Streaking | Low | Low | Low | Medium | Medium | Low to |
| | | | | | | Medium |
| Filming | Low | Low | Low | Medium | Low | Low to |
| | | | | | | medium |

Low residue quat/betaine based disinfecting formulations, described in Table 5, were evaluated for antimicrobial efficacy against Staphylococcus aureus (ATCC 6538). The testing was performed in accordance with the protocols outline in AOAC official method 961.02 Germicidal Spray products as Disinfectants, modified for use with wipes.

Cultures of S. aureus and sterile glass test carriers were prepared. Microbial concentrations of three carriers were enumerated prior to test initiation to determine pre-test carrier microbial concentrations. The test carriers were placed in petri dishes lined with sterile filter paper. The carriers were then inoculated with S. aureus by spreading the culture evenly across the surface of the carrier and allowing the culture to dry. The dry, contaminated test carrier surfaces were then sprayed, individually, with the disinfecting samples. The microbial concentrations of three test carriers were enumerated to determine post-test carrier microbial concentrations. Contaminated test surfaces were incubated in the disinfectant for a specified contact time and then transferred, individually, to sterile test tubes or jars containing a neutralization/growth media and incubated for 48 hours. After incubation, the number of tubes showing growth of the target microorganism was recorded. The formulations were then recorded as “pass” or “fail” based on the number of test surfaces demonstrating complete disinfection.

As illustrated in Table 5 below, all of the disinfecting formulations containing a betaine surfactant passed the antimicrobial efficacy test.

TABLE 5
Antimicrobial efficacy testing results of qual/betaine
based disinfecting samples against S. aureus

| Components | | | | |
|---|---|---|---|---|
| (amount in wt. %, | Sample No. | | | |
| D.I. water added to | Sam- | Sam- | Sam- | Sam- |
| 100%) | ple 24 | ple 25 | ple 26 | ple 27 |
| alkyl dimethyl benzyl and | 0.3788 | 0.3788 | 0.3788 | 03788 |
| dialkyl dimethyl ammonium | | | | |
| chloride | | | | |
| sodium metasilicate | 0.026 | — | — | — |
| pentahydrate | | | | |
| monoethanolamine | — | 0.026 | 0.026 | 0.026 |
| tetrasodium EDTA | 0.053 | 0.053 | 0.053 | 0.053 |
| ethoxylated alkyl | 0.105 | — | 0.105 | — |
| (C12-14) alcohol | | | | |
| coco amido propyl | 0.9 | 0.9 | 0.55 | 0.55 |
| dimethyl betaine | | | | |
| isopropanol | 0.4 | 0.4 | — | — |
| propylene glycol | — | — | 0.4 | 0.4 |
| n-butyl ether | | | | |
| AOAC Modified GST | Pass | Pass | Pass | Pass |
| Antimicrobial efficacy | | | | |
| results against S. aureus | | | | |

Further examples of low residue quat/betaine based disinfecting formulations are provided in Table 6 below.

TABLE 6
Examples of low streaking concentrate formulations

| | Sample No. | | | |
|---|---|---|---|---|
| Components | Sam- | Sam- | Sam- | Sam- |
| (amount in wt. %) | ple 28 | ple 29 | ple 30 | ple 31 |
| alkyl dimethyl benzyl and | 11.87 | 15.83 | 15.83 | 15.83 |
| dialkyl dimethyl ammonium | | | | |
| chloride | | | | |
| sodium metasilicate | 0.66 | — | — | — |
| pentahydrate | | | | |
| monoethanolamine | — | 0.88 | 0.88 | 0.88 |
| tetrasodium EDTA | 3.50 | 4.67 | 4.67 | 4.67 |
| ethoxylated alkyl | 2.63 | — | — | — |
| (C12-14) alcohol | | | | |
| coco amido | 61.00 | 49.5 | 49.5 | 49.5 |
| propyl dimethyl (37%) | | | | |
| isopropanol | 10.00 | — | 10.0 | — |
| propylene glycol | — | — | — | 10.0 |
| n-butyl ether | | | | |
| D.I. water | 10.34 | 29.12 | 19.12 | 19.12 |
| Dilution rate | 4% | 3% | 3% | 3% |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A wiping composition for disinfecting surfaces with reduced streaking, the wiping composition comprising an aqueous solution containing an antimicrobial agent and a residue reducing surfactant, the antimicrobial agent comprising a quaternary ammonium cation, the residue reducing surfactant comprising an amphoteric surfactant, the antimicrobial agent being present in the wiping composition in relation to the residue reducing surfactant at a weight ratio of from about 1:0.2 to about 1:10.

2. A wiping composition as defined in claim 1, wherein the amphoteric surfactant comprises a betaine surfactant.

3. A wiping composition as defined in claim 1, wherein the quaternary ammonium cation comprises a halide salt of a quaternary ammonium cation.

4. A wiping composition as defined in claim 1, wherein the quaternary ammonium cation comprises an alkyl dimethyl benzyl ammonium chloride, a dialkyl dimethyl ammonium chloride, an alkyl dimethyl ethyl benzyl ammonium chloride, or mixtures thereof.

5. A wiping composition as defined in claim 1, where in the residue reducing surfactant comprises cocoamidopropyl betaine.

6. A wiping composition as defined in claim 1, where the only solvent contained in the wiping composition is water.

7. A wiping composition as defined in claim 1, wherein the composition further contains a chelating agent and a pH builder, the pH builder comprising a silicate, the wiping composition further containing at least one nonionic surfactant, the nonionic surfactant comprising an ethoxylated alcohol, and wherein the antimicrobial agent is present in the aqueous solution in an amount less than about 2% by weight, and wherein the residue reducing surfactant is present in the aqueous solution in an amount less than about 2% by weight, and wherein water is contained in the wiping composition in an amount greater than about 90% by weight.

8. A wiping composition as defined in claim 1, wherein the residue reducing surfactant has the following formula: 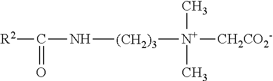
wherein R² comprises an alkyl group having up to 20 carbon atoms.

9. A wiping composition as defined in claim 1, wherein the residue reducing surfactant comprises decyl betaine, myristyl betaine, palmityl betaine, lauryl betaine, cetyl betaine, stearyl betaine, coco dimethyl carboxymethyl betaine (“cocobetaine”), cocoamidoethyl betaine, cocoamidopropyl betaine, lauramidopropyl betaine, myristyl amidopropyl betaine, lauryl dimethyl carboxymethyl betaine, lauryl dimethyl alpha-carboxy-ethyl betaine, cetyl dimethylcarboxymethyl betaine, lauryl bis-(2-hydroxy-ethyl) carboxy methyl betaine, stearyl bis-(2-hydroxy-propyl) carboxymethylbetaine, oleyl dimethyl gamma-carboxypropyl betaine, lauryl bis-(2-hydroxypropyl) alpha-carboxyethyl betaine, cocoamidopropyl dimethyl betaine, or mixtures thereof.

10. A wiping composition as defined in claim 1, wherein the residue reducing surfactant comprises a polymeric betaine.

11. A wiping composition as defined in claim 10, wherein the residue reducing surfactant has the following formula:

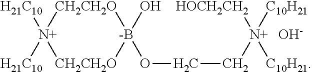

12. A wiping composition as defined in claim 1, wherein the antimicrobial agent comprises a di C8-C12 alkyl ammonium chloride.

13. A wiping composition as defined in claim 1, wherein the wiping composition comprises a concentrate that is diluted prior to use, the concentrate containing the quaternary ammonium cation in an amount of from about 5% to about 40% by weight.

14. A wiping composition as defined in claim 1, wherein the quaternary ammonium cation comprises a carbonate/bicarbonate salt of a quaternary ammonium cation.

15. A premoistened wiping product comprising:
a liquid absorbent substrate; and
a wiping composition contained within the substrate, the wiping comprising an aqueous solution containing an antimicrobial agent combined with a residue reducing surfactant, the antimicrobial agent comprising a quaternary ammonium cation, the residue reducing surfactant comprising an amphoteric surfactant.

16. A premoistened wiping product as defined in claim 15, wherein the residue reducing surfactant comprises a betaine surfactant or polymeric betaine.

17. A premoistened wiping product as defined in claim 15, wherein the residue reducing surfactant comprises cocoamidopropyl betaine.

18. A premoistened wiping product as defined in claim 15, wherein the residue reducing surfactant has the following formula: 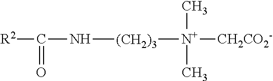
wherein R² comprises an alkyl group having up to 20 carbon atoms.

19. A premoistened wiping product as defined in claim 15, wherein the residue reducing surfactant has the following formula:

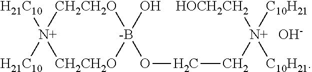

20. A premoistened wiping product as defined in claim 15, wherein the antimicrobial agent is present in relation to the residue reducing agent at a weight ratio of from about 1:0.2 to about 1:10.

21. A premoistened wiping product as defined in claim 15, wherein the antimicrobial agent is present in the aqueous solution in an amount less than 1% by weight, and wherein the residue reducing surfactant is present in the aqueous solution in an amount less than about 2% by weight, and wherein the wiping composition further contains at least one nonionic surfactant comprising an ethoxylated alcohol, and wherein the wiping composition further contains a silicate, and wherein the quaternary ammonium cation comprises a di C8 to C12 alkyl ammonium chloride.

22. A premoistened wiping product as defined in claim 15, wherein the liquid absorbent substrate comprises a nonwoven web and wherein the liquid absorbent substrate comprises a meltblown web, a coform web, a spunbond web, an airlaid web, an airlaced web, a hydroentangled web, a bonded carded web, or a laminate thereof.
